(19) United States
(12) Patent Application Publication
(10) Pub. No.: US 2014/0058993 A1
(43) Pub. Date: Feb. 27, 2014

(54) HIGH-SPEED DECISION APPARATUS AND METHOD FOR HARMFUL CONTENTS

(71) Applicant: Electronics and Telecommunications Research Institute, Daejeon (KR)

(72) Inventor: Jae-Deok LIM, Daejeon (KR)

(21) Appl. No.: 13/933,069

(22) Filed: Jul. 1, 2013

(30) Foreign Application Priority Data
Aug. 21, 2012 (KR) 10-2012-0091319

(51) Int. Cl. G06N 5/02

(52) U.S. Cl. CPC G06N 5/02
USPC 706/46

(57) ABSTRACT

A high-speed decision apparatus and method for harmful contents, capable of determining whether contents are harmful by performing a harmfulness determination operation on only some sections, rather than all sections, of the content, based on the content playback characteristic that when content having a harmful part is played, the harmful part continues to be played for a certain period of time.

### CROSS-REFERENCE TO RELATED APPLICATION

This application claims the benefit under 35 U.S.C. §119(a) of Korean Patent Application No. 10-2012-0091319, filed on Aug. 21, 2012, in the Korean Intellectual Property Office, the entire disclosure of which is incorporated herein by reference for all purposes.

### BACKGROUND

1. Field

The following description relates to technology for analyzing contents, and more particularly, to a high-speed decision apparatus and method for harmful contents.

2. Description of the Related Art

In conventional techniques for high-speed decision of content harmfulness, a hash-based determination method has been commonly used. According to the hash-based determination method, hash values of known harmful contents are obtained and made into a database, and a hash value of content to be analyzed for harmfulness is obtained and compared with the hash value made into a database in advance, thereby checking whether the content is harmful.

The hash-based method in which hash values are represented in a database in advance is very fast at determining whether contents are harmful, but has a fatal disadvantage in that new harmful contents, i.e., harmful contents not yet in the database, cannot be determined. This makes it inadequate for the present contents service environment which is flooded with new contents.

In order to make up for this shortcoming, a method of determining harmful multimedia contents by using playback characteristics of multimedia contents has been suggested in Korean Patent Publication No. 10-2012-0070667 (Published on Jul. 3, 2012) filed by the same applicant and inventor as the present disclosure.

The suggested method is to determine a local harmfulness of each basic unit section of contents by use of a content playback characteristic according to which if content having a harmful part is played, the harmful part continues to be played for a certain period of time.

The inventor of the present disclosure conducted research into more effective determination of harmful content using harmful contents determination technology utilizing contents playback characteristics such as the technology described above.

### SUMMARY

The following description relates to a high-speed decision apparatus and method for harmful contents that are capable of effectively determining whether contents are harmful by use of a contents playback characteristic according to which if content having a harmful part is played, the harmful part continues to be played for a certain period of time.

In one general aspect, a high-speed decision apparatus for harmful contents, includes a unit section harmfulness analyzer, and an analysis unit section determiner. The unit section harmfulness analyzer may be configured to analyze harmfulness of a basic unit section that is determined to be an analysis unit section among basic unit sections forming content to determine whether the analysis unit section is harmful. The analysis unit section determiner may be configured to, if a current analysis unit section is determined to be harmful by the unit section harmfulness analyzer, determine a basic unit section positioned just behind the current analysis unit section to be a next analysis unit section, and if the current analysis unit section is determined not to be harmful by the unit section harmfulness analyzer, determine a basic unit section to which the current analysis unit section is shifted by a predetermined number of basic unit sections to be a next analysis unit section.

When the current analysis unit section is determined to be harmful and a basic unit section positioned just behind the current analysis unit section is determined to be the next analysis unit section, if the current analysis unit section is a last basic unit section forming the content and there is no next basic unit section, the analysis unit section determiner may end determination of an analysis unit section.

When the current analysis unit section is determined not to be harmful, and a basic unit section to which the current analysis unit section is shifted by the predetermined number of basic unit sections is determined to be the next analysis unit section, if the number of remaining basic unit sections is below a predetermined number and there is no next analysis unit section, the analysis unit section determiner may determine a basic unit section positioned just behind the current analysis unit section to be the next analysis unit section.

The high-speed decision apparatus may further include a start position determiner configured to determine a starting basic unit section from which analysis of harmfulness starts.

The start position determiner may determine a first basic unit section among the basic unit sections forming the content to be the starting basic unit section from which analysis of harmfulness starts.

The high-speed decision apparatus may further include a basic unit section number calculator configured to calculate the number of basic unit sections forming the content by dividing the content by a size of the basic unit section.

The high-speed decision apparatus may further include a harmfulness proportion calculator configured to calculate a proportion of harmfulness by comparing the number of the basic unit sections of the content calculated by the basic unit section number calculator with the number of analysis unit sections determined to be harmful by the unit section harmfulness analyzer.

The high-speed decision apparatus may further include a content harmfulness determiner configured to determine content as harmful if the proportion of harmfulness calculated by the harmfulness proportion calculator is equal to or greater than a threshold value.

In another general aspect, a high-speed decision method of determining harmfulness of contents includes: a basic unit section number calculation operation of calculating, by a high-speed decision apparatus for harmful contents, a number of basic unit sections forming content by dividing the content by a size of the basic unit section; a start position determination operation of determining, by the high-speed decision apparatus for harmful contents, a starting basic unit section from which analysis of harmfulness starts; a unit section harmfulness analysis operation of performing, by the high-speed decision apparatus for harmful contents, analysis of harmfulness on basic unit sections that are determined to be analysis unit sections, starting from the determined starting basic unit section, to determine harmfulness of each of the analysis unit sections; an analysis unit section determination operation of determining, by the high-speed decision apparatus for harmful contents, if a current analysis unit section is determined to be harmful, a basic unit section positioned just behind the current analysis unit section to be a next analysis unit section, and if the current analysis unit section is determined not to be harmful, a basic unit section to which the current analysis unit section is shifted by a predetermined number of basic unit sections to be the next analysis unit section; a harmfulness proportion calculation operation of calculating, by the high-speed decision apparatus for harmful contents, if the current analysis unit section is determined to be harmful, a proportion of harmfulness by comparing the number of basic unit sections of content with the number of analysis unit sections determined to be harmful; and a content harmfulness determination operation of determining, by the high-speed decision apparatus for harmful contents, the content to be harmful if the proportion of harmfulness calculated is equal to or greater than a threshold value.

In the analysis unit section determination operation, when the current analysis unit section is determined to be harmful and a basic unit section positioned just behind the current analysis unit section is determined to be the next analysis unit section, if the current analysis unit section is a last basic unit section forming the content and there is no next basic unit section, the high-speed decision apparatus may end determination of an analysis unit section.

In the analysis unit section determination operation, when the current analysis unit section is determined not to be harmful and a basic unit section to which the current analysis unit section is shifted by the predetermined number of basic unit sections to be the next analysis unit section, if a number of remaining basic unit sections is below a predetermined number and there is no next analysis unit section, the high-speed decision apparatus may determine a basic unit section positioned just behind the current analysis unit section to be the next analysis unit section.

In the start position determination operation, the high-speed decision apparatus may determine a first basic unit section among the basic unit sections forming the content to be the starting basic unit section from which analysis of harmfulness starts.

Other features and aspects will be apparent from the following detailed description, the drawings, and the claims.

### BRIEF DESCRIPTION OF THE DRAWINGS

FIG. 1 is a block diagram illustrating the configuration of a high-speed decision apparatus for harmful contents in accordance with an example of the present disclosure.

FIG. 2 is a view illustrating division of content into basic unit sections.

FIG. 3 is a view illustrating an operation of determining a next analysis unit section in a case in which a current analysis unit section is determined to be harmful.

FIG. 4 is a view illustrating an operation of determining a next analysis unit section in a case in which a current analysis unit section is not determined to be harmful.

FIG. 5 is a view illustrating an operation of determining an analysis unit section in a case in which the number of remaining basic unit sections is below a predetermined number and a next basic unit section does not exist.

FIG. 6 is a flowchart illustrating a configuration of a high-speed decision method of determining harmfulness of contents in accordance with an embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Various changes, modifications, and equivalents of the methods, apparatuses, and/or systems described herein will suggest themselves to those of ordinary skill in the art. Also, descriptions of well-known functions and constructions may be omitted for increased clarity and conciseness.

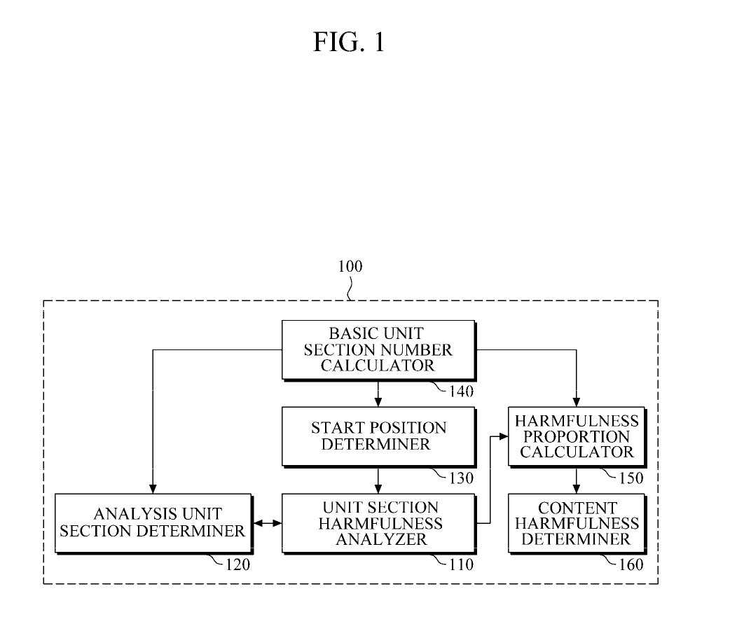

FIG. 1 is a block diagram illustrating the configuration of a high-speed decision apparatus for harmful contents in accordance with an example of the present disclosure. Referring to FIG. 1, a high-speed decision apparatus for harmful contents 100 includes a unit section harmfulness analyzer 110 and an analysis unit section determiner 120.

The unit section harmfulness analyzer 110 analyzes harmfulness of a basic unit section that is determined to be an analysis unit section among basic unit sections forming content, to determine harmfulness of the corresponding analysis unit section.

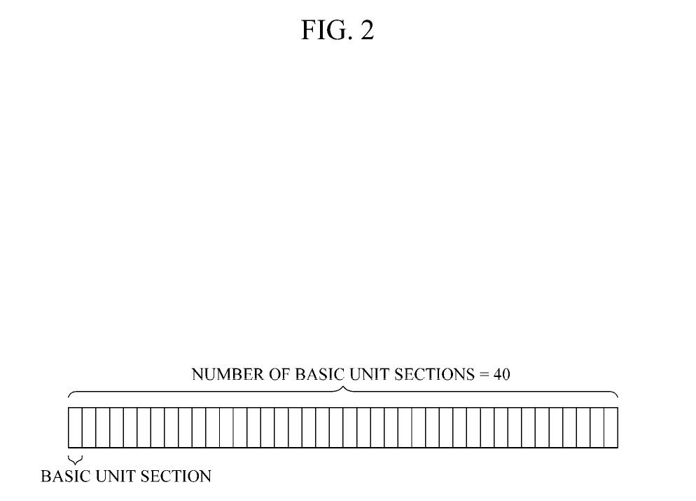

FIG. 2 is a view illustrating division of content into basic unit sections. For example, assuming that the size of a content file is 40 secs, and a basic unit forming the content is determined to be 1 sec, the corresponding content is formed of 40 basic unit sections.

For example, the unit section harmfulness analyzer 110 may be embodied to determine harmfulness of an analysis unit section by comparing predetermined harmfulness pattern data with analysis unit section data. Meanwhile, the predetermined harmfulness pattern data may be virus pattern data and hacking pattern data.

The unit section harmfulness analyzer 110 determines harmfulness of analysis unit sections determined by the analysis unit section determiner 120, starting from a starting basic unit section from which analysis of harmfulness starts.

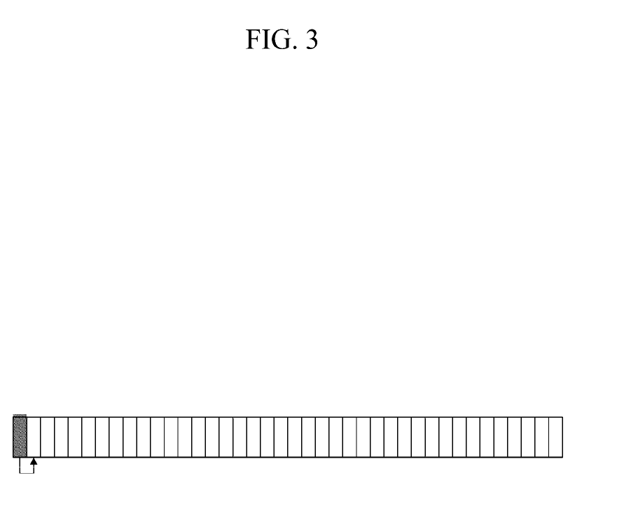

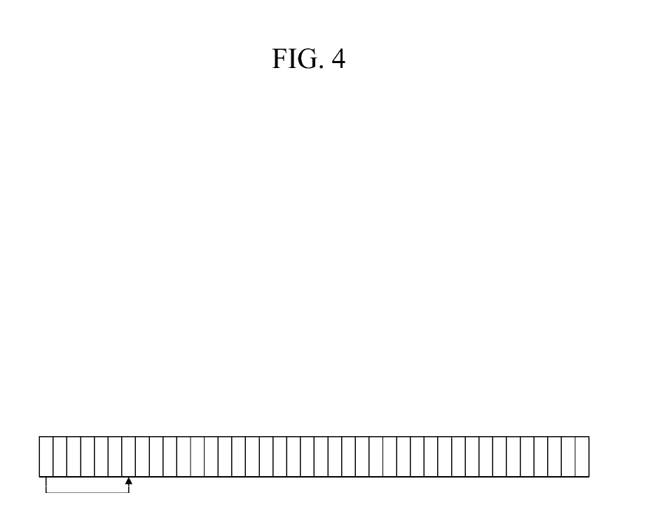

The analysis unit section determiner 120, in a case in which a current analysis unit section is determined to be harmful by the unit section harmfulness analyzer 110, determines a basic unit section located just behind the current analysis unit section to be a next analysis unit section as shown in FIG. 3, and in a case in which a current analysis unit section is determined not to be harmful by the unit section harmfulness analyzer 110, determines a basic unit section to which the current analysis unit section is shifted by a predetermined number of basic unit sections to be a next analysis unit section as shown in FIG. 4.

Meanwhile, in a case in which the current analysis unit section is determined to be harmful and a basic unit section located just behind the current analysis section is determined to be a next analysis unit section, if the current analysis unit section is a last basic unit section forming the content, the analysis unit section determiner 120 ends the determination of an analysis unit section.

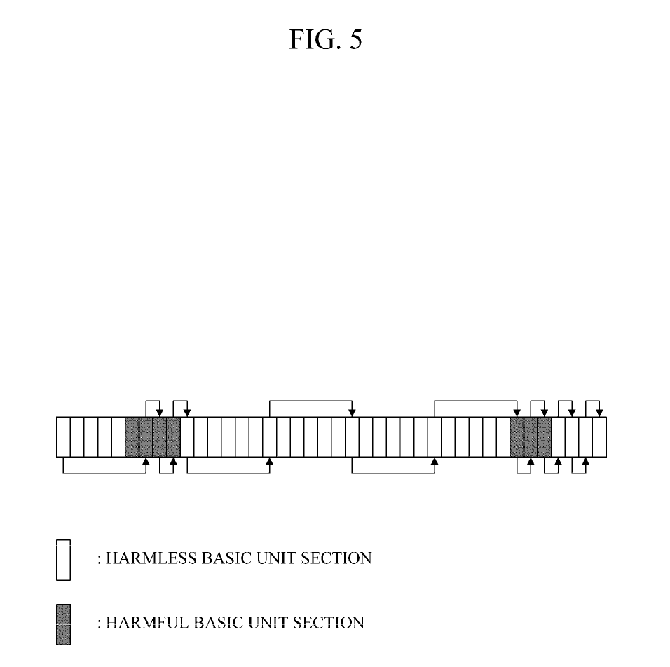

Meanwhile, in a case in which the current analysis unit section is determined not to be harmful and a basic unit section to which the current analysis unit section is shifted by a predetermined number of basic unit sections is determined to be the next analysis unit section, if the number of remaining basic unit sections is below a predetermined number and there is no next analysis unit section, the analysis unit section determiner 120 determines a basic unit section positioned just behind the current analysis unit section to be the next analysis unit section as shown in FIG. 5.

Meanwhile, in accordance with an additional aspect, the high-speed decision apparatus for harmful contents 100 may further include a start position determiner 130. The start position determiner 130 determines a starting basic unit section from which analysis of harmfulness starts.

For example, the start position determiner 130 may be embodied to determine a first basic unit section among the basic unit sections forming the content to be the starting basic unit section from which analysis of harmfulness starts

Thereafter, the unit section harmfulness analyzer 110 determines the harmfulness of the analysis unit sections determined by the analysis unit section determiner 120, starting from the starting basic unit section determined by the start position determiner 130.

Meanwhile, in accordance with an additional aspect, the high-speed decision apparatus for harmful contents 100 may further include a basic unit section number calculator 140. The basic unit section number calculator 140 calculates the number of basic unit sections forming the content by dividing the content by a size of the basic unit section. For example, the number of basic unit sections may be calculated as the basic unit section number calculator 140 divides the content by the size of the basic unit section as shown in FIG. 2.

Meanwhile, in accordance with an additional aspect, the high-speed decision apparatus for harmful contents 100 may further include a harmfulness proportion calculator 150. The harmfulness proportion calculator 150 calculates a proportion of harmfulness by comparing the number of the basic unit sections of the content calculated by the basic unit section number calculator 140 with the number of analysis unit sections determined to be harmful by the unit section harmfulness analyzer 110.

For example, if the number of basic unit sections of content calculated by the basic unit section number calculator 140 is 40, and the number of analysis unit sections determined to be harmful by the unit section harmfulness analyzer 110 is 12, the proportion of harmfulness calculated by the harmfulness proportion calculator 150 is (12/40)*100%=30%.

Meanwhile, in accordance with an additional aspect, the high-speed decision apparatus for harmful contents 100 may further include a content harmfulness determiner 160. The content harmfulness determiner 160 determines content to be harmful if the proportion of harmfulness calculated by the harmfulness proportion calculator 150 is equal to or greater than a threshold value.

If the threshold value is 30%, and the proportion of harmfulness calculated by the harmfulness proportion calculator 150 is 50%, the content harmfulness determiner 160 determines the content to be harmful. Meanwhile, if the threshold value is 30%, and the proportion of harmfulness calculated by the harmfulness proportion calculator 150 is 10%, the content harmfulness determiner 160 determines the content to be harmless.

According to the above embodiment of the present disclosure, it is determined whether content is harmful at a high speed by performing harmfulness determination on some sections of the content rather than all sections of the content, based on the content playback characteristic that when content having a harmful part is played, the harmful part continues to be played for a certain period of time.

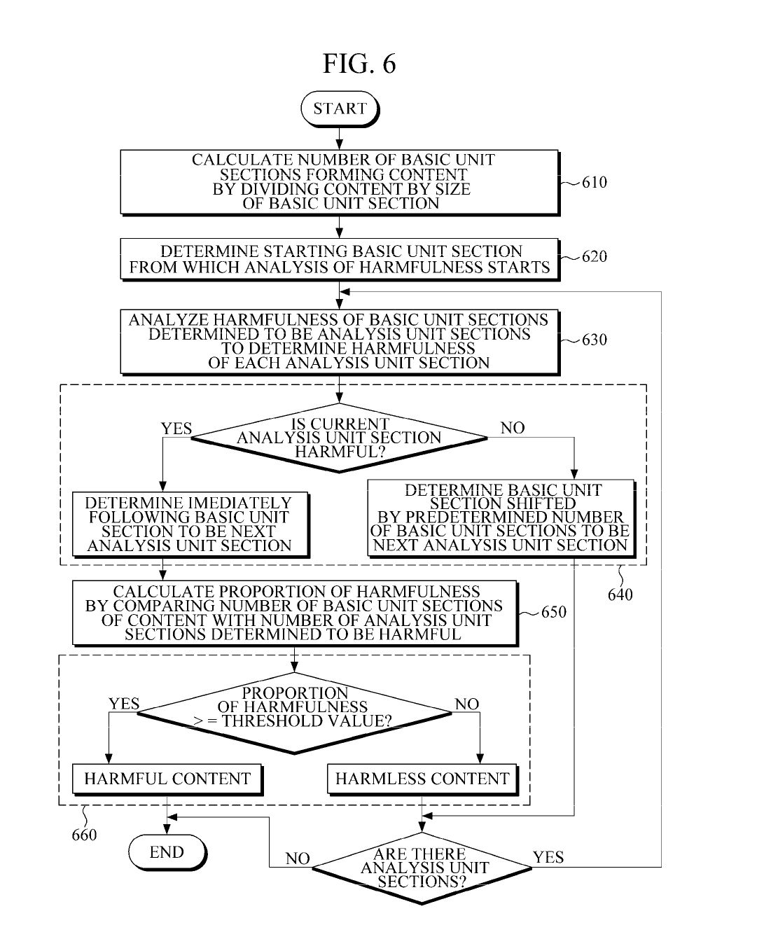

Hereinafter, an operation of determining whether contents are harmful using the high-speed decision apparatus for harmful contents in accordance with the present disclosure will be described with reference to FIG. 6. FIG. 6 is a flowchart illustrating a configuration of a high-speed decision method of determining harmfulness of contents in accordance with an example of the present disclosure.

First, in a basic unit section number calculation operation in 610, the high-speed decision apparatus for harmful contents calculates the number of basic unit sections forming corresponding content by dividing the content by a size of the basic unit section.

Thereafter, in a start position determination operation in 620, the high-speed decision apparatus for harmful contents determines a starting basic unit section from which analysis of harmfulness starts. In this case, in the start position determination operation in 620, a first basic unit section among the basic unit sections forming the content may be determined to be the starting basic unit section from which analysis of harmfulness starts.

Thereafter, in a unit section harmfulness analysis operation in 630, the high-speed decision apparatus for harmful contents performs analysis of harmfulness on basic unit sections that are determined to be analysis unit sections, starting from the determined starting basic unit section, to determine harmfulness of each of the analysis unit sections.

For example, in the unit section harmfulness analysis operation of 630, the high-speed decision apparatus for harmful contents may be embodied to determine the harmfulness of an analysis unit section by comparing predetermined harmfulness pattern data with analysis unit section data. Meanwhile, the predetermined harmfulness pattern data may be virus pattern data and hacking pattern data.

In an analysis unit section determination operation in 640, the high-speed decision apparatus for harmful contents, if a current analysis unit section is determined to be harmful in the unit section harmfulness analysis operation in 630, determines a basic unit section positioned just behind the current analysis unit section to be a next analysis unit section, and if the current analysis unit section is determined not to be harmful, determines a basic unit section to which the current analysis unit section is shifted by a predetermined number of basic unit sections to be a next analysis unit section.

In the analysis unit section determination operation in 640, when the current analysis unit section is determined to be harmful and a basic unit section positioned just behind the current analysis unit section is determined to be the next analysis unit section, if the current analysis unit section is a last basic unit section forming the content and there is no next basic unit section, the high-speed decision apparatus for harmful contents ends determination of an analysis unit section.

In the analysis unit section determination operation in 640, when the current analysis unit section is determined not to be harmful and a basic unit section to which the current analysis unit section is shifted by the predetermined number of basic unit sections to be the next analysis unit section, if a number of remaining basic unit sections is below a predetermined number and there is no next analysis unit section, the high-speed decision apparatus for harmful contents determines a basic unit section positioned just behind the current analysis unit section to be the next analysis unit section.

In a harmfulness proportion calculation operation in 650, if the current analysis unit section is determined to be harmful, the high-speed decision apparatus for harmful contents calculates a proportion of harmfulness by comparing the number of the basic unit sections of the content calculated in the basic unit section number calculation operation in 610 with the number of analysis unit sections determined to be harmful in the unit section harmfulness analysis operation in 630.

In content harmfulness determination operation in 660, the high-speed decision apparatus for harmful contents determines a content to be harmful if the proportion of harmfulness calculated in the harmfulness proportion calculation operation in 650 is equal to or greater than a threshold value.

According to the above embodiment of the present disclosure, it is determined whether content is harmful at a high speed by performing the harmfulness determination on some sections of the content rather than all sections of the content, based on the content playback characteristic that when content having a harmful part is played, the harmful part continues to be played for a certain period of time.

As apparent from the above description, the determination of harmfulness is not made with respect to all sections of contents, and by use of the contents playback characteristic that when contents having a harmful section is played, the harmful section continues to be played for a predetermined period of time, can be made with respect to only some sections of the contents, thereby allowing for high-speed decision of contents harmfulness.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as those used in Internet transmission. In addition, the computer-readable recording medium may be distributed among computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A high-speed decision apparatus for harmful contents, comprising:
a unit section harmfulness analyzer configured to analyze harmfulness of a basic unit section that is determined to be an analysis unit section among basic unit sections forming content and to determine whether the analysis unit section is harmful; and
an analysis unit section determiner configured to, if a current analysis unit section is determined to be harmful by the unit section harmfulness analyzer, determine a basic unit section positioned just behind the current analysis unit section to be a next analysis unit section, and if the current analysis unit section is determined not to be harmful by the unit section harmfulness analyzer, determine a basic unit section shifted by a predetermined number of basic unit sections from the current analysis unit section to be a next analysis unit section.

2. The high-speed decision apparatus for harmful contents of claim 1, wherein when the current analysis unit section is determined to be harmful and a basic unit section positioned just behind the current analysis unit section is determined to be the next analysis unit section, if the current analysis unit section is a last basic unit section forming the content and there is no next basic unit section, the analysis unit section determiner ends determination of an analysis unit section.

3. The high-speed decision apparatus for harmful contents of claim 1, wherein when the current analysis unit section is determined not to be harmful and a basic unit section shifted by the predetermined number of basic unit sections from the current analysis unit section to be the next analysis unit section, if a number of remaining basic unit sections is below a predetermined number and there is no next analysis unit section, the analysis unit section determiner determines a basic unit section positioned just behind the current analysis unit section to be the next analysis unit section.

4. The high-speed decision apparatus for harmful contents of claim 1, further comprising:
a start position determiner configured to determine a starting basic unit section from which analysis of harmfulness starts.

5. The high-speed decision apparatus for harmful contents of claim 4, wherein the start position determiner determines a first basic unit section among the basic unit sections forming the content to be the starting basic unit section from which analysis of harmfulness starts.

6. The high-speed decision apparatus for harmful contents of claim 4, further comprising:
a basic unit section number calculator configured to calculate the number of basic unit sections forming the content by dividing the content by a size of the basic unit section.

7. The high-speed decision apparatus for harmful contents of claim 6, further comprising:
a harmfulness proportion calculator configured to calculate a proportion of harmfulness by comparing the number of the basic unit sections of the content calculated by the basic unit section number calculator with the number of analysis unit sections determined to be harmful by the unit section harmfulness analyzer.

8. The high-speed decision apparatus for harmful contents of claim 7, further comprising:
a content harmfulness determiner configured to determine content to be harmful if the proportion of harmfulness calculated by the harmfulness proportion calculator is equal to or greater than a threshold value.

9. A high-speed decision method for harmful contents, comprising:
calculating, by a high-speed decision apparatus for harmful contents, number of basic unit sections forming content by dividing the content by a size of the basic unit section;
determining, by the high-speed decision apparatus for harmful contents, a starting basic unit section from which analysis of harmfulness starts;
performing, by the high-speed decision apparatus for harmful contents, analysis of harmfulness on basic unit sections that are determined to be analysis unit sections, starting from the determined starting basic unit section, to determine harmfulness of each of the analysis unit sections;
determining, by the high-speed decision apparatus for harmful contents, if a current analysis unit section is determined to be harmful, a basic unit section positioned just behind the current analysis unit section to be a next analysis unit section, and if the current analysis unit section is determined not to be harmful, a basic unit section shifted by a predetermined number of basic unit sections from the current analysis unit section to be a next analysis unit section;
calculating, by the high-speed decision apparatus for harmful contents, if the current analysis unit section is determined to be harmful, a proportion of harmfulness by comparing the number of basic unit sections of content with the number of analysis unit sections determined to be harmful; and
determining, by the high-speed decision apparatus for harmful contents, the content to be harmful if the proportion of harmfulness calculated is equal to or greater than a threshold value.

10. The high-speed decision method for harmful contents of claim 9, wherein in the determining of the analysis unit section, when the current analysis unit section is determined to be harmful and a basic unit section positioned just behind the current analysis unit section is determined to be the next analysis unit section, if the current analysis unit section is a last basic unit section forming the content and there is no next basic unit section, the high-speed decision apparatus ends determination of an analysis unit section.

11. The high-speed decision method for harmful contents of claim 9, wherein in the determining of the analysis unit section, when the current analysis unit section is determined not to be harmful and a basic unit section shifted by the predetermined number of basic unit sections from the current analysis unit section to be the next analysis unit section, if a number of remaining basic unit sections is below a predetermined number and there is no next analysis unit section, the high-speed decision apparatus for harmful contents determines a basic unit section positioned just behind the current analysis unit section to be the next analysis unit section.

12. The high-speed decision method for harmful contents of claim 9, wherein in the determining of the starting basic unit section, the high-speed decision apparatus for harmful contents determines a first basic unit section among the basic unit sections forming the content to be the starting basic unit section from which analysis of harmfulness starts.
